(19) United States
(12) Patent Application Publication
(10) Pub. No.: US 2015/0167936 A1
(43) Pub. Date: Jun. 18, 2015

(54) LED WALL PACK

(71) Applicant: SHENZHEN YAORONG TECHNOLOGY CO., LTD., Shenzhen, Guangdong (CN)

(72) Inventor: Xing Chun Yong, Shenzhen (CN)

(21) Appl. No.: 14/418,355

(22) PCT Filed: Mar. 3, 2014
(86) PCT No.: PCT/CN2014/072817

§ 371 Date: Jan. 29, 2015

(30) Foreign Application Priority Data
Mar. 5, 2013 (CN) 201320100178.4

(51) Int. Cl. F21V 15/01; F21V 23/02; F21V 29/83; F21S 8/00

(52) U.S. Cl. CPC F21V 15/01; F21S 8/036; F21V 23/023; F21V 29/83; F21Y 2101/02

(57) ABSTRACT

This invention discloses an LED wall pack, which comprises a power supply box; a power supply disposed in the power supply box; a door covered on the power supply box; wherein the LED wall pack also comprises a heat sink, an LED light panel, and a transparent or translucent protective case; in which the LED light panel is connected to the power supply and secured to the front side of the health sink; the protective case is covered on the LED light panel and is secured to the front side of the heat sink; the door is secured on the back side of the heat sink; and the heat sink is connected with the power supply box. The LED wall pack of the invention has good heat dissipation, provides uniform light, enables easy maintenance, and provides long usage life. It can be widely used in the field of lighting.

### TECHNICAL FIELD OF THE INVENTION

The present invention generally relates to the field of LED lighting apparatus, and more particularly, to an LED wall pack.

### BACKGROUND OF THE INVENTION

The traditional wall pack which uses general light bulb and incandescent bulb is not as energy-saving or durable as LED light. Not only do they have low luminous efficiency, high energy consumption and short usage life, they are also affected by poor sealing and uneven light. As the seal design was not used, heat dissipation is therefore not considered.

### SUMMARY OF THE INVENTION

In response to the aforementioned shortcomings, this invention aims at providing an LED wall pack with good cooling effects and uniform light, which can solve the problems of the absence of cooling design, uneven illumination, low energy efficiency, and short life of the existing wall pack.

To solve the aforementioned technical problems, this invention is implemented through the following technical solutions:
a power supply box;
a power supply disposed in the power supply box;
a door covered on the power supply box; wherein the LED wall pack also comprises a heat sink, an LED light panel, and a transparent or translucent protective case; in which the LED light panel is electrically connected to the power supply and is secured to the front side of the heat sink; the protective case is covered on the LED light panel and is secured to the front side of the heat sink; the door is secured on the rear side of the heat sink; and the heat sink is connected with the power supply box.

Preferably, to help air flow and accelerate cooling, the heat sink is shaped as a funnel, and a plurality of holes is disposed on both the top and bottom portions of the heat sink.

Preferably, the heat sink is shaped as a funnel, and a plurality of holes is disposed on both the top and bottom portions of the heat sink.

Preferably, the heat sink is has a trapezoidal cross-section.

Preferably, Fresnel teeth is provided on an inner surface of the protective case.

Preferably, the protective case has a triangle cross-section.

Preferably, the heat sink is movably connected with one end of the power supply box through a rotary shaft, and the other end of the power supply box is fixed with a fastener.

Preferably, silicone is coated on the area between the LED light panel and the heat sink to improve heat dissipation.

Preferably, the heat sink, the power supply box, and the door are made of aluminum.

Preferably, the protective case is made of PC, glass, or acrylic.

Preferably, a lightning protection device is arranged on the power supply.

This invention, compared with the existing technology in this art, may possess the following beneficial effects:
1) extending the life of LED wall pack, because the LED wall pack of this invention, protects the power supply and LED light panel by the tight seal in the power supply box, the door, the protective case, etc.;
2) facilitating the airflow and accelerating the heat dissipation, because the heat sink of the LED wall pack of the invention appears to be in funnel-shaped, with holes on both the upper and lower portions of the heat sink; and getting more better heat dissipation since the heat sink, the power supply box, and the door are all made of aluminum, with the space between the LED light panel and heat sink being coated with silicone;
3) converging the light and focusing on areas that need to be illuminated because the inner surface of the protective case of the LED wall pack has Fresnel teeth; and obtaining uniform light by changing the shape of the Fresnel teeth to adjust the even lighting of the lamp;
4) being easy to open the door for maintenance since the heat sink is movably connected with one end of the power supply box through a rotary shaft, and the other end is fixed with fastener;
5) enhancing the anti-lightning effect because the power supply of the LED wall pack is equipped with a lightning protection device, which can also improve safety, and extend the usage life.

### BRIEF DESCRIPTIONS OF THE DRAWINGS

FIG. 1 a schematic view of the LED wall pack of the present invention;

FIG. 2 a schematic view of one side of the LED wall pack of the present invention;

FIG. 3 is an exploded view of the major component of the LED wall pack of the present invention; and

FIG. 4 is a schematic view of the protective case of the LED wall pack of the present invention.

### DETAILED DESCRIPTIONS OF THE INVENTION

To better understand this invention, detailed description of the present invention are set forth below in conjunction with the accompany drawings.

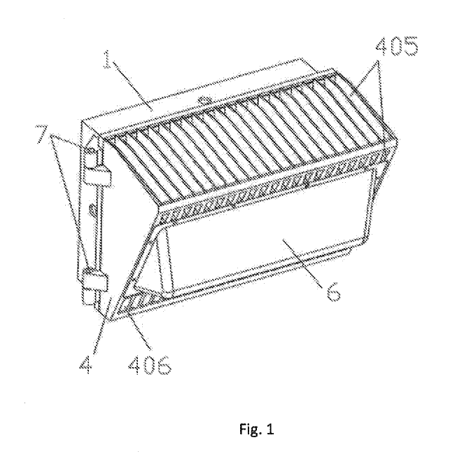

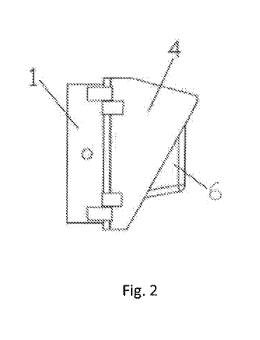

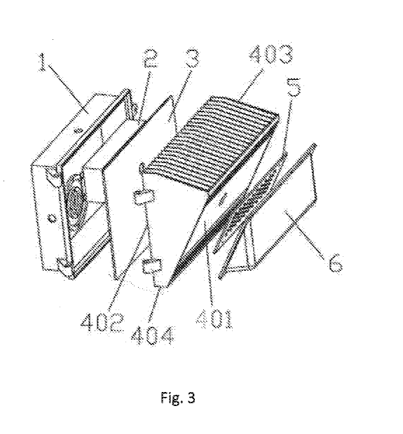

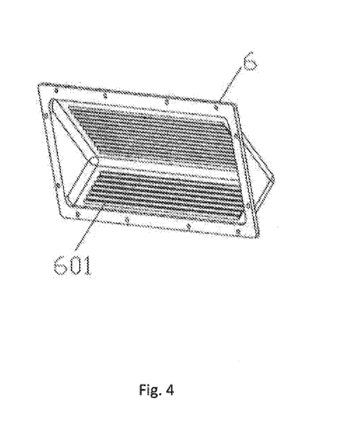

Referring to FIG. 1, FIG. 2, FIG. 3 and FIG. 4, the present invention of an LED wall pack is disclosed, which mainly comprises a power supply box 1, a power supply 2, a door 3, a heat sink 4, an LED light panel 5, a transparent or translucent protective case 6. The power supply 2 is secured inside the power supply box 1, whereas the power supply box 1 is covered by the door 3. The LED light panel 5 is electrically connected to the power supply 2 and is fixed on the front side of heat sink 401. The protective case 6 is covered on the LED light panel 5 and is secured on the front side 401 of the heat sink 4. The door 3 is fixed on the rear side 402 of the heat sink 4 and the heat sink 4 is connected with the power supply box 1.

To facilitate airflow, accelerate heat dissipation, and avoid accumulation of dusts, the heat sink 4 can be designed in funnel shape, in which a plurality of holes 405 and 406 are disposed on the upper portion 403 and lower portion 404 of the heat sink 4. The cross-section of the heat sink can be in trapezoidal shape.

To converge the light and focus on areas that need to be illuminated, Fresnel teeth are arranged on the inner surface 601 of the protective case 6. By changing the shape of the Fresnel teeth, the illumination of the lighting fixtures can be adjusted, resulting in uniform light in the above area. The cross section of protective cover 6 can appear in triangular shape, and the materials for making the protective cover 6 can be Polycarbonate (PC), glass, acrylic, etc.

To easily open the door for maintenance, the heat sink 4 is movably connected to one end of the power supply box 1 through a rotary shaft 7, whereas the other end of the power supply box 1 is fixed with fastener.

To accelerate heat dissipation, silicone is coated on the area between the LED light panel 5 and the heat sink 4. Aluminum can be chosen as the materials to make the heat sink 4, the power supply box 1, and the door 3.

To strengthen the anti-lightning effects and to improve safety, a lightning protection device is provided in the power supply 2, which can extend the usage life of the corner LED light.

The power supply box 1 has mounting holes, by which the entire LED wall pack can be fixed on the wall, thereby achieving the illumination purpose. When in use, the power supply 2 is electrically connected to the external power supply.

The invention of LED wall pack can possess good heat dissipation, provide uniform light, enable easy maintenance, and provide long usage life.

The aforementioned are only preferred embodiments of the present invention, and shall not be intended to limit the invention. It should be noted that for those skilled in the art, any modifications, equivalent replacements or improvements, etc., made in the essence and principles of this invention should be included in the protection scope of this invention.

1. An LED wall pack comprising:
a power supply box;
a power supply disposed in the power supply box;
a door covered on the power supply box; wherein the LED wall pack also comprises a heat sink, an LED light panel, and a transparent or translucent protective case; in which the LED light panel is electrically connected to the power supply and is secured to the front side of the heat sink; the protective case is covered on the LED light panel and is secured to the front side of the heat sink; the door is secured on the rear side of the heat sink; and the heat sink is connected with the power supply box.

2. The LED wall pack according to claim 1, wherein the heat sink is shaped as a funnel, and a plurality of holes is disposed on both the top and bottom portions of the heat sink.

3. The LED wall pack according to claim 1, wherein the heat sink is has a trapezoidal cross-section.

4. The LED wall pack according to claim 1, wherein Fresnel teeth is provided on an inner surface of the protective case.

5. The LED wall pack according to claim 4, wherein the protective case has a triangle cross-section.

6. The LED wall pack according to claim 4, wherein the heat sink is movably connected with one end of the power supply box through a rotary shaft, and the other end of the power supply box is fixed with a fastener.

7. The LED wall pack according to claim 6, wherein silicone is coated on the area between the LED light panel and the heat sink to improve heat dissipation.

8. The LED wall pack according to claim 7, wherein the heat sink, the power supply box, and the door are made of aluminum.

9. The LED wall pack according to claim 4, the protective case is made of PC, glass, or acrylic.

10. The LED wall pack according to claim 4, wherein a lightning protection device is arranged on the power supply.
